(19) United States
(12) Patent Application Publication
(10) Pub. No.: US 2021/0397192 A1
(43) Pub. Date: Dec. 23, 2021

(54) Method and Device for Determining a Functional Road Class and a Most Probable Route for a Motor Vehicle

(71) Applicant: Bayerische Motoren Werke Aktiengesellschaft, Muenchen (DE)

(72) Inventors: Esther ALBERTS, Muenchen (DE); Stefan HOLDER, Muenchen (DE); Maxim SIDOROV, Muenchen (DE)

(21) Appl. No.: 17/221,940

(22) Filed: Apr. 5, 2021

(30) Foreign Application Priority Data
Jun. 17, 2020 (DE) 10 2020 115 950.1

(51) Int. Cl. G05D 1/02; G01C 21/34

(52) U.S. Cl. CPC G05D 1/0217; G05D 2201/0213; G01C 21/3461; G05D 1/0291

(57) ABSTRACT

A method provides a functional road class of route sections of a digital map. The method regularly or continuously provides present geographic positions of a plurality of vehicles of a vehicle fleet in a central unit; determines navigation attributes for all route sections of a digital map in dependence on the geographic positions of the plurality of vehicles; and respectively assigns functional road classes to the route sections in dependence on the navigation attributes. A most probable route can be determined by joining route sections to one another, wherein starting from a respective observed route section, which initially corresponds to the geographic position of the vehicle, the route sections are expanded by adding a further route section in dependence on the functional road class.

### CROSS REFERENCE TO RELATED APPLICATION

This application claims priority under 35 U.S.C. § 119 from German Patent Application No. 10 2020 115 950.1, filed Jun. 17, 2020, the entire disclosure of which is herein expressly incorporated by reference.

### BACKGROUND AND SUMMARY OF THE INVENTION

The invention relates to vehicle functions which use a most probable route of a motor vehicle, in particular to optimize the vehicle operation.

To predict operating parameters of a vehicle, it is generally necessary to assume a most probable upcoming route. For example, the course of the most probable route can be used for energy management in hybrid vehicles and other functions. In particular, the determination of a most probable route enables the determination of an accumulated operating parameter, for example an energy consumption within a prediction horizon.

For example, the determination of the most probable route along route sections of a digital map can be determined in dependence on a route section attribute and a direction change angle from one route section to a next route section in a digital map, wherein at each intersection or junction, the route section having the highest road class value is selected. If all route sections coming into consideration have the same road class value, the route section having the smallest change angle of the direction of travel is preferred.

However, the calculation of the most probable route on the basis of the road class of the route sections of the digital map has the disadvantage that the road classes stored therein were optimized for navigation applications, in particular for the calculation of shortest and fastest paths. However, the accuracy of the predictions with the aid of the most probable routes is possibly not sufficient for other predictions of operating variables of the vehicle.

One object is thus to provide a possibility, for a driver assistance function or a vehicle function, of improving the determination of the most probable route independently of the application, in order to thus improve the prediction of operating variables of the vehicle, in particular over a prediction horizon.

This and other objects are achieved by the method for determining functional road classes and by the method for determining a most probable route and corresponding devices, according to the independent claims. Further embodiments are specified in the dependent claims.

According to one aspect, a method is provided for providing a functional road class of route sections of a digital map, having the following steps:
regularly or continuously providing present geographic positions of a plurality of vehicles of a vehicle fleet in a central unit;
determining navigation attributes for all route sections of a digital map in dependence on the geographic positions of the plurality of vehicles;
respectively assigning functional road classes to the route sections in dependence on the navigation attributes.

The determination of a most probable route is performed based on a digital map which represents a network of route sections connected to one another. Route attributes are assigned to the route sections. One of the route attributes can correspond to a functional road class, which specifies a general usability of the relevant route section.

The classification of functional road classes up to this point has generally been carried out according to the type of the road, for example freeway, residential road, transit road, and the like. These are prioritized with the aid of road class values, so that the highest road class value corresponds to the freeway and the lowest road class value corresponds to a residential road. For the determination of a most probable route without any previous knowledge about the destination, at each intersection or junction, the route section which has the highest road class value is selected as the next route section.

However, the assignment of the functional road class to the route sections can differ in reality from the actual usability of the respective route section. A freeway route section can thus actually be used less than a highway if the freeway route section is awkward to navigate and proves to be unfavorable for many destinations, for example due to onramp and offramp locations. However, up to this point, in the case of a junction into a freeway route section and a highway route section, due to the higher road class value, the freeway route would be assumed as the next route section of the most probable route if no further specifications are present, for example about the destination of the journey.

The above method therefore envisages registering the actual usage behavior of the individual route sections of a digital map and deriving road class values therefrom. This is possible by evaluating fleet data, whereby navigation attributes of the route sections can be registered over a longer time period, for example of multiple days or months. The road class values are then defined according to the navigation attributes, for example a navigation frequency or an average velocity.

By using collected fleet data, the actual usage and usability of a route section can be determined, so that a corresponding road class value can be assigned to the route section. Upon the use of the functional road classes, the most probable route is therefore not exclusively assumed on the basis of the intended use of the relevant route sections, for example freeway, residential road, transit road, highway, and the like, but rather according to the actual use by road users. This enables an improved prediction of a most probable route. Moreover, this enables a simple determination algorithm to be maintained for the determination of a most probable route in dependence on the road classes.

It can be provided that the navigation attributes specify a navigation frequency of the route sections and in particular an average movement velocity of the vehicles on the route sections within a predetermined time period.

Furthermore, the functional road classes can be classified by road class values, which are assigned to proportional ranges of one or multiple navigation attributes of the route sections with respect to an entirety of the one or multiple navigation attributes of all route sections of the digital map.

The use of fleet data can take place in a central unit, which has a communication connection to a plurality of vehicles of a vehicle fleet. Position data and optionally velocity data are received there from the vehicles of the vehicle fleet at regular time intervals, for example in time periods between 0.5 and 10 seconds or, for example, every second. These data can be collected in the central unit and can be determined for each route section of a digital map in accordance with the navigation frequency, i.e. the number of traversals of each route section per time window, and optionally an average navigation velocity. Subsequently, the navigation frequency and possibly the average velocities are assigned to a functional road class, in particular a specification of a road class value.

For example, the classification into the functional road classes can be established on the basis of proportion ranges of navigation frequencies in the total number of navigations of the route sections of the digital map. The highest road class value can thus be assigned to those route sections for which more than a predetermined proportion of traversals was took place in relation to the total number of navigations of the route sections. Further road classes can be classified by means of the proportion ranges thus determined.

In particular, the functional road classes for the route sections can also be assigned depending on time, in particular depending on times of day.

Alternatively or additionally, the functional road classes can be assigned precisely by lane for multilane route sections. Due to the registration of the navigation attributes precisely by lane, an improved turnoff prediction can be enabled for the next intersection or junction and an improved lane change prediction can be enabled on multilane driving routes. In particular, an assignment of the functional road classes precisely by lane can be used upon a use of a most probable route generated therefrom in a lane change assistant function and in automatic lateral guidance.

According to a further aspect, a method is provided for determining a most probable route for use in a vehicle function of a vehicle of a vehicle fleet, wherein a digital map having route sections and having functional road classes assigned to the route sections is provided, wherein the functional road class is determined according to the above method, wherein a most probable route is determined by joining route sections to one another, wherein starting from a respective observed route section, which initially corresponds to the geographic position of the vehicle, the route sections joined to one another are expanded by adding a further route section in dependence on the functional road class, wherein a vehicle function is carried out in dependence on the most probable route.

According to a further aspect, a device is provided, in particular a central unit, for providing a functional road class of route sections of a digital map, wherein the device is designed to:
regularly or continuously receive present geographic positions from a plurality of vehicles of a vehicle fleet in a central unit;
determine navigation attributes for all route sections of a digital map in dependence on the geographic positions of the plurality of vehicles;
respectively assign functional road classes to the route sections in dependence on the navigation attributes; and
provide the digital map having the functional road classes for each route section.

According to a further aspect, a device is provided for determining a most probable route for use in a vehicle function of a vehicle, wherein the device is designed to:
receive a digital map having route sections and having functional road classes assigned to the route sections,
determine a most probable route by joining route sections to one another,
starting from a respective observed route section, which initially corresponds to the geographic position of the vehicle, expand the route sections joined to one another by adding a further route section in dependence on the functional road class,
carry out a vehicle function in dependence on the most probable route.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of a system having a vehicle fleet and a central unit for determining functional road classes of route sections of a digital map.

FIG. 2 is a flow chart to illustrate a method for providing functional road classes.

FIG. 3 is a flow chart for usage of the functional road classes from the central unit in a motor vehicle.

FIG. 4 is a graphic representation of a digital map having functional road classes assigned to the route sections.

### DETAILED DESCRIPTION OF THE DRAWINGS

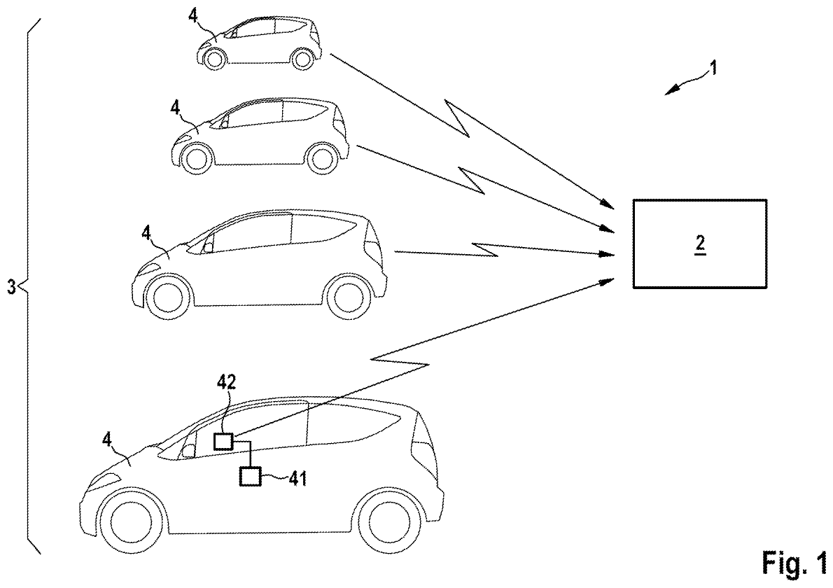

FIG. 1 shows a schematic illustration of a system 1 having a vehicle fleet 3 made up of a plurality of vehicles 4 and a central unit 2. Each of the vehicles 4 has a communication connection to the central unit 2.

For this purpose, each of the vehicles 4 has a control unit 41, which has a communication connection via a communication device 42 to the central unit 2.

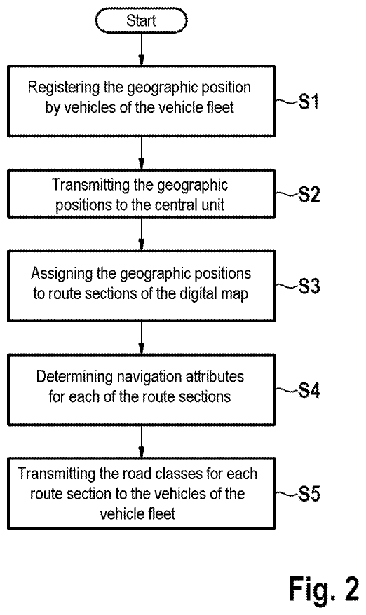

In conjunction with the flow chart of FIG. 2, a method for providing navigation attributes of route sections of a digital map is described hereinafter.

In step S1, the vehicles 4 register, with the aid of a suitable geopositioning system, for example GPS, GLONASS, and the like, the ego geographic position and the ego instantaneous velocity and transmit them in step S2 at regular time intervals, for example between 0.5 and 10 s, in particular every second, to the central unit 2.

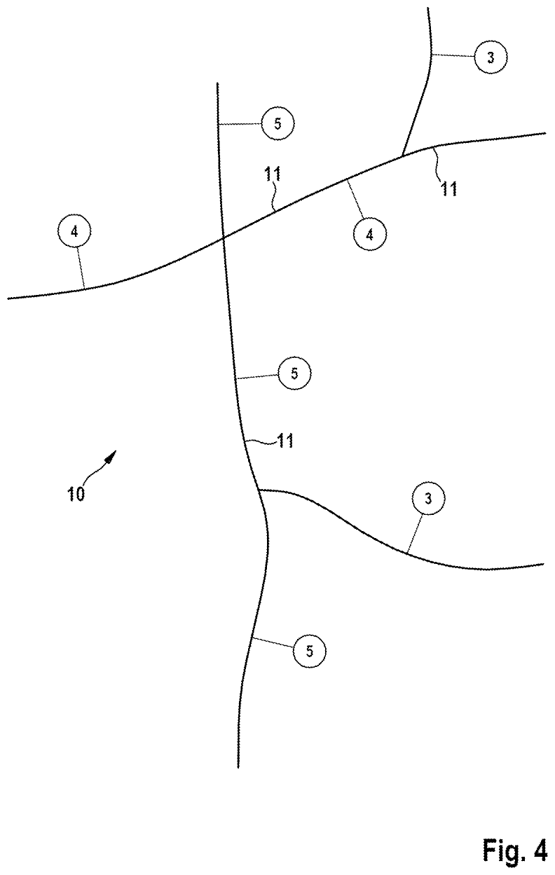

In the central unit 2, in step S3, the geographic positions of the vehicles are assigned to corresponding route sections of a digital map, which represents a road network of the real world. An exemplary digital map is shown in FIG. 4. A route network 10 made up of route sections 11 connected to one another can be seen.

In step S4, corresponding navigation attributes are calculated for each route section 11 of the digital map. In particular, the navigation frequencies within a time period, for example within one day or within one week, are determined by accumulation of navigations of a route section 11 and average velocities are assigned to the respective route sections 11. The time period of the registration is selected so that the navigation frequency can be ensured with a sufficient statistical significance and relevance. Subsequently, the route sections 11 of the digital map are assigned road class values in dependence on the navigation frequencies and possibly the average velocities.

The road class values thus determined, which are shown as values in the circles in FIG. 4, can be transmitted back, in a manner assigned to route sections of a digital data map, in step S5 to the vehicles 4 of the vehicle fleet 3, so that the most probable route can be determined therein.

The classification and assignment of the road class values to the navigation frequencies can be carried out in dependence on the proportion of traversals taking place in a route section in relation to the total number of traversals of the entire geographic region covered by the digital map taking place in all route sections.

Thus, for example, the highest road class, which is indicated, for example, by the road class value 5, can be assigned to the route sections on which more than a specific percentage, for example 0.1%, of all traversals have occurred. Accordingly, further road classes can be assigned to the route sections, in each of which a proportion of traversals of a proportion range specified for a relevant road class has resulted. For example, a further road class, for example indicated by a road class value of 4, can be assigned to a proportion range of, for example, 0.03% to 0.1%.

The road classes can moreover also be assigned accordingly to times of day, i.e. different road classes can be assigned to the route sections, depending on in which time of day range the determination of the most probable route takes place. Thus, for example, in particular for weekdays, different road class values can be assumed for the time periods from 6 AM to 9 AM and 4 PM to 8 PM, since in the morning many journeys take place in the direction of the workplace and in the evening many journeys take place in the direction of the residence.

Moreover, the determination of the road classes can also take place precisely by lane on the route sections, so that possibly various road classes can be assigned to the different driving lanes. In particular, an assignment of the functional road classes precisely by lane can be used upon a use of a most probable route generated therefrom in a lane change assistant function and in automatic lateral guidance.

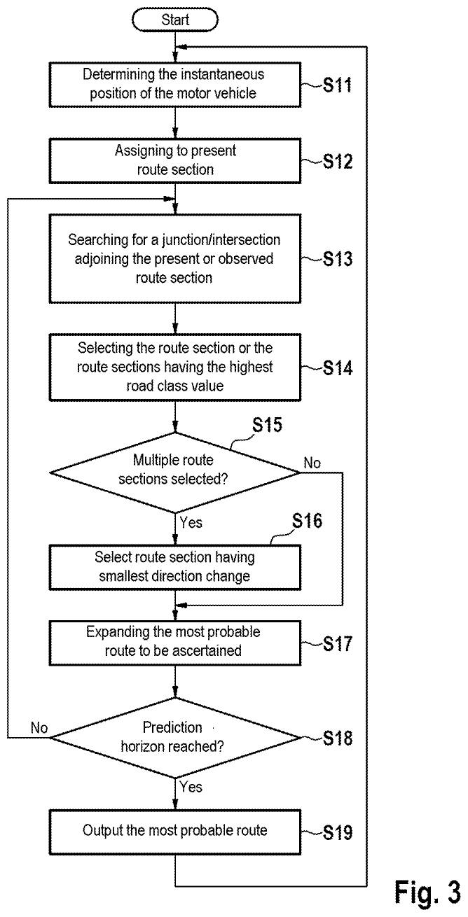

The method for determining the most probable route is explained in greater detail in the flow chart of FIG. 3. This method can be applied in each of the vehicles 4 of the vehicle fleet 3.

In step S11, an instantaneous geographic position of a vehicle 4 is determined.

In step S12, the instantaneous position of the vehicle 4 is assigned with the aid of the map data to a route section on the digital map.

Proceeding from the present or a most recently observed route section, in step S13, a most probable route is now determined based on the road classes. For this purpose, the most probable route is built up route section by route section. Starting from the present or observed route section 11, the next intersection or junction is sought in the direction of travel.

The route sections 11 adjoining the intersection or the junction are studied with respect to their functional road class values. In step S14, a route section is selected which has the highest road class value.

In step S15, it is checked whether multiple route sections having the highest of the road class values of the adjoining route sections originate from the present intersection/junction. If this is the case (alternative: yes), in step S16, the route section is selected which induces a smaller angle of a direction change of the vehicle with respect to the present or preceding route section and expands the most probable route by the route section thus determined. Otherwise (alternative: no), the most probable route is expanded directly in step S17 by the route section determined in step S14.

In step S18, it is checked whether the most probable route has a sufficient length, i.e., extends over the entire prediction horizon, which can correspond to a predetermined path length or a predetermined duration. If this is the case (alternative: yes), the most probable route is signaled in step S19 to a downstream vehicle function, otherwise (alternative: no), the method is continued with step S13.

Energy management or destination guidance or guiding without explicit destination specification can be carried out as possible vehicle functions which use the most probable route.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 system
2 central unit
3 vehicle fleet
4 vehicle
41 control unit
42 communication device
10 road network
11 route section

What is claimed is:

1. A computer-implemented method for providing a functional road class of route sections of a digital map, the method comprising the steps of:
regularly or continuously providing present geographic positions of a plurality of vehicles of a vehicle fleet in a central unit;
determining navigation attributes for all route sections of a digital map in dependence on the geographic positions of the plurality of vehicles; and
respectively assigning functional road classes to the route sections in dependence on the navigation attributes.

2. The method according to claim 1, wherein
the navigation attributes specify a navigation frequency of the route sections.

3. The method according to claim 1, wherein
the navigation attributes specify an average movement velocity of the vehicles on the route sections within a predetermined time period.

4. The method according to claim 1, wherein
the functional road classes are classified by road class values, which are assigned to proportional ranges of one or multiple navigation attributes of the route sections with respect to an entirety of the one or the multiple navigation attributes of all route sections of the digital map.

5. The method according to claim 4, wherein
the functional road classes for the route sections are also assigned depending on times of day.

6. The method according to claim 5, wherein
the functional road classes are assigned precisely by lane for multilane route sections.

7. The method according to claim 4, wherein
the functional road classes are assigned precisely by lane for multilane route sections.

8. A computer-implemented method for determining a most probable route for use in a vehicle function of a vehicle of a vehicle fleet, wherein a digital map having route sections and having functional road classes assigned to the route sections is provided, wherein the functional road class is determined according to claim 1,
the method comprising the steps of:
determining a most probable route by joining route sections to one another, wherein starting from a respective observed route section, which initially corresponds to the geographic position of the vehicle, the route sections joined to one another are expanded by adding a further route section in dependence on the functional road class, and
carrying out a vehicle function in dependence on the most probable route.

9. A device for providing a functional road class of route sections of a digital map, wherein the device is operatively configured to:
regularly or continuously receive present geographic positions from a plurality of vehicles of a vehicle fleet in a central unit;
determine navigation attributes for all route sections of a digital map in dependence on the geographic positions of the plurality of vehicles;
respectively assign functional road classes to the route sections in dependence on the navigation attributes; and
provide the digital map having the functional road classes for each route section.

10. A device for determining a most probable route for use in a vehicle function of a vehicle, wherein the device is operatively configured to:
receive a digital map having route sections and having functional road classes assigned to the route sections;
determine a most probable route by joining route sections to one another;
starting from a respective observed route section, which initially corresponds to the geographic position of the vehicle, expand the route sections joined to one another by adding a further route section in dependence on the functional road class; and
carry out a vehicle function in dependence on the most probable route.
